(19) United States
(12) Patent Application Publication
(10) Pub. No.: US 2006/0147632 A1
(43) Pub. Date: Jul. 6, 2006

(54) Composition and process for coloring and preserving wood

(76) Inventors: Jun Zhang, Getzville, NY (US); Wenjin Zhang, Tonawanda, NY (US)

Correspondence Address: HODGSON RUSS LLP, ONE M & T PLAZA, SUITE 2000, BUFFALO, NY, 14203-2391, US

(21) Appl. No.: 11/299,522

(22) Filed: Dec. 12, 2005

Related U.S. Application Data
(63) Continuation-in-part of application No. 11/126,839, filed on May 11, 2005.
(63) Continuation-in-part of application No. 11/116,152, filed on Apr. 27, 2005.
(60) Provisional application No. 60/570,659, filed on May 13, 2004.
(60) Provisional application No. 60/565,585, filed on Apr. 27, 2004.

(51) Int. Cl. C09D 5/14; C09D 5/16; B05D 3/00

(52) U.S. Cl. 427/297; 106/15.05; 106/18.32

(57) ABSTRACT

Provided is a composition which can color and preserve wood. The composition comprises both micronized pigments and inorganic and/or organic biocides, which may be present as a dispersion, emulsion or in solution also provided is a one step method for the coloring and preservation of wood.

This application is a continuation-in-part of U.S. Non-provisional application No. 11/126,839 filed on May 11, 2005, which claims priority to U.S. Provisional application No. 60/570,659 filed on May 13, 2004, the disclosure of which is incorporated herein by reference. This application is also a continuation-in-part of U.S. Non-provisional application Ser. No. 11/116,152 filed on Apr. 27, 2005, which claims priority to U.S. Provisional application No. 60/565,585 filed on Apr. 27, 2004, the disclosure of which is hereby incorporated by reference.

### FIELD OF THE INVENTION

This invention relates to a composition and method for both coloring and preserving cellulosic products, such as wood, to improve their outdoor weathering properties and their resistance to rot- and decay-causing organisms or environmental agents. More particularly, the invention relates to a composition and method whereby coloring and preserving of wood may be accomplished in a single application step, or sequentially, in two separate application steps, which may be performed in either order.

### BACKGROUND OF THE INVENTION

Wood which is both colored and preserved is used extensively in the construction industry in applications including siding, fencing, and decking. It has long been desirable to produce wood products that have an aesthetically pleasing appearance and good outdoor weathering properties, and yet have resistance to attack by wood destroying agencies such as fungi, bacteria and insects.

Untreated wood, when exposed to an outdoor environment, is subject to bio-deterioration due to attack by decay fungi and insects. In addition, untreated wood is subject to photo-degradation which will cause yellowing, fading, graying and, over time, a darkening of the wood surface.

Traditionally, wood preservative solutions used by wood preservation industry to impart resistance to fungal and insect attack contain metals or metal complexes. Examples are chromated copper arsenate (CCA), alkaline copper quaternary ammonium compounds (ACQ) and others, such as those described in American Wood Preservers' Association Standards-2005. These preservative systems not only provide decay and termite resistance, but also provide protection against photo-degradation due to the presence of metal or metal complexes which can act as absorbers and/or blockers of ultraviolet radiation. Unfortunately, many of the metal-based preservatives impart an undesirable color to the wood.

Thus, the wood preservation industry is increasingly interested in non-traditional preservatives, such as organic preservatives or non-metal based preservatives. However, such preservatives generally weather poorly upon exposure to sunlight. In fact, wood which has been treated with these preservatives can weather as poorly as wood which has not undergone treatment.

It is well known that colorants can do more than simply enhance the aesthetic appearance of the wood. Colorants can enhance the resistance of wood to UV photo-degradation, improving the weathering properties of the wood.

Thus colorants have been used in conjunction with preservatives in an attempt to improve weathering properties of preserved wood.

One technique currently used to color wood is to paint the surface of the wood with an oil or water based pigment paint coating. However, paint often will not adhere to preservative-treated wood, resulting in blistering or flaking of the coating in a short period of time.

Additionally, a critical failure of this and other coating methods is that they provide surface coloration which may wear away, requiring additional treatment or servicing if long term weathering is desired.

Another technique currently used to color wood is to add water soluble dyes to the preservative solution and thereby impart color to treated wood products. However, water soluble dyes, such as acid dyes or cationic dyes, generally have poor lightfastness, generally fading or decomposing upon exposure to sunlight, particularly ultra violet (UV) wavelengths.

In view of the many shortcomings of the current methods of coloring and preserving wood, it is desirable to have a coloring and preserving system that provides an aesthetically pleasing appearance, long-term weathering performance, and resistance to biodeterioration. It is also desirable to have a coloring and preserving process which can, if desired, be completed in a single application step.

### SUMMARY OF THE INVENTION

Provided are colorant compositions that can be used in conventional preservative systems as well as metal-free or organic preservative systems. The colorant compositions comprise dispersions of inorganic and/or organic pigments in the form of micronized particles. The composition additionally comprises inorganic and/or organic biocides, which may be micronized or present as an emulsion or in solution. If desired, the compositions can comprise emulsions of inorganic and/or organic pigments instead of or in addition to dispersions.

The compositions can be used to both preserve the wood from biodeterioration and color the wood in a single application.

Also provided is a method for preserving and coloring wood comprising the step of impregnating wood with a such a composition.

Also provided is a method for coloring and preserving wood comprising the steps of:

1) impregnating the wood with a composition comprising a dispersion comprising one or more micronized pigments; and

2) impregnating the wood with a composition comprising a preservative or biocide; wherein the steps are conducted in either order.

Another object of this invention is to provide a one step method for simultaneously 1) imparting lightfast, uniform color to wood and 2) preserving wood.

A further object of this invention is to provide a method of impregnating color beneath the surface of wood to provide for long term application.

Still another object of this invention is to provide a method for imparting color to wood which improves the outdoor weathering properties of wood.

Pigment formulations have been used to coat and paint wood. However, the present invention pertains to the coloring and preserving of wood by impregnation with pigment and biocides, sequentially or in a single step, giving a preserved product having lightfast, non-flaking color. Impregnation into wood imparts to the wood excellent UV resistance, and thus, excellent weathering characteristics.

In accordance with the present invention there is provided a composition for preserving and coloring wood. The composition comprises a preservative composition which protects wood from bio-deterioration. The composition further comprises one or more pigment dispersions and can be used to simultaneously preserve and color wood. The pigment dispersion comprises micronized inorganic pigments, such as, for example, iron oxides, carbon black, zinc oxides, titanium oxides and chrome oxides; and/or micronized organic pigments.

Also provided is a method for the treatment of wood or wood product with the compositions of the present invention

When wood is treated with the preservative composition of the present invention both the preservative and the pigments are carried beneath the surface of the wood, imparting long lasting color to the wood and preserving it from biological degradation.

### BRIEF DESCRIPTION OF THE FIGURES

The patent or application file contains at least one drawing executed in color. Copies of this patent or patent application publication with color drawing(s) will be provided by the Office upon request and payment of the necessary fee.

FIG. 1 depicts the anatomy of coniferous wood. A: Resin canal; B: Earlywood tracheids; C: Latewood tracheids; D: Bordered pits.

FIG. 2 depicts the border pit structure for coniferous woods.

RIGHT: Microscopic view of the cross section of a bordered pit.

LEFT: Torus in top view. The torus is supported by a net of radial fibril membrane, also called the margo. The flow of fluids between two tracheids through such a membrane is restricted by the size of the membrane openings. A: Pit aperture; B: Torus; C: Margo (microfibrils); D: Pit border

FIG. 3 depicts the superior outdoor weathering of wood treated with tebuconazole and micronized red brown pigment formulation (3B) versus treatment with tebuconazole alone (3A).

FIG. 4 depicts the superior outdoor weathering of wood treated with quaternary ammonium compound and micronized green pigment formulation (4B) versus treatment with quaternary ammonium compound alone (4A).

FIG. 5 demonstrates the effect of QUV test on the wood samples treated with a preservative alone (dimethyl didecyl ammonium quat). Delignification and graying were observed after one month of QUV weathering.

FIG. 6 demonstrates the effect of QUV test on the wood samples treated with a preservative (azole based preservative) plus a light-brown iron oxide-based pigment formulation. Only slight color change observed after one month of QUV weathering.

### DETAILED DESCRIPTION OF THE INVENTION

The present invention provides compositions and methods for preserving and coloring wood and wood products. The composition comprises a preservative solution such as a metal containing formulation or an organic or metal-free preservative formulations, and a pigment composition. In a preferred embodiment, the preservative solution comprises metal complexes, preferably copper complexes. In another preferred embodiment, the preservative solution comprises organic or metal free preservative formulations, preferably quaternary ammonium compounds; azoles, particularly tebuconazole, propiconazole, or cyproconazole; pyrethrins, particularly bifenthrin, permethrin, cypermethrin; imidachloprid; fipronil, or a combination of the foregoing. In another preferred embodiment, the pigments are red iron oxide, yellow iron oxide, black iron oxide, carbon black.

The present invention pertains to the use of pigment dispersions to color and preserve wood. The difference between pigments and dyes is generally understood by one of skill in the art. Pigments are generally more lightfast and have a greater resistance to UV degradation than dyes. Another difference that pigments generally have little or no solubility in the medium in which they are applied. Thus, if the composition of the present invention is applied as an aqueous dispersion, the pigment is generally one which has little or no solubility in water. The present invention is primarily directed toward applications which include the use of pigments in an aqueous carrier. However, pigment dispersions in other carriers, such as polar or nonpolar organic carriers, including oil carriers are within the ambit of the invention. Non-limiting examples of non-aqueous carriers which can be used are oil carriers such as, for example, mineral oil, linseed oil, soybean oil, AWPA p-9 oil, and other known in the art. In general, the term “pigment” as used herein refers to a wood coloring substance which, when applied in a carrier, has a solubility of less than Ig per 100 grams carrier in the chosen carrier, and preferably less than 0.5 g or 0.1 g per 100 grams of carrier (at 25° C.). For the purposes herein, a coloring compound which is applied in a non-aqueous carrier will be considered a pigment if it has a solubility of less than or equal to 0.1 g per-100 grams of carrier at 25° C. More preferred is a solubility of less than or equal to 0.1 g per 100 grams of carrier at 25° C. Furthermore, the coloring compound also should have a water solubility of less than 1 g per 100 grams of water at 25° C., and preferably less than 0.5 or 0.1 g per 100 g of water.

The pigments which can be used in the compositions of the present invention include inorganic and organic pigments. Inorganic pigments include compounds of metals such as iron, zinc, titanium, lead, chromium, copper, cadmium, calcium, zirconium, cobalt, magnesium, aluminum, nickel, and other transition metals. Carbon black is also an inorganic pigment.

Some non-limiting examples of suitable inorganic pigments include: iron oxides, including red iron oxides, yellow iron oxides, black iron oxides and brown iron oxides; carbon black, iron hydroxide, graphite, black micaceous iron oxide; aluminum flake pigments, pearlescent pigments; calcium carbonate; calcium phosphate; calcium oxide; calcium hydroxide; bismuth oxide; bismuth hydroxide; bismuth carbonate; copper carbonate; copper hydroxide; basic copper carbonate; silicon oxide; zinc carbonate; barium carbonate, barium hydroxide; strontium carbonate; zinc oxide; zinc phosphate; zinc chromate; barium chromate; chrome oxide; titanium dioxide; zinc sulfide and antimony oxide, lead chrome, and cadmium pigments.

Preferred inorganic pigments are carbon black; graphite; iron oxides, including yellow, red, black and brown iron oxides; zinc oxide; titanium oxide and aluminum-based pigments, such as, for example Al₂O₃ Al(OH)₃.

Non-limiting examples of organic pigments include Monoazo (arylide) pigments such as PY3, PY65, PY73, PY74, PY97 and PY98; Disazo (diarylide); Disazo condensation; Benzimidazolone; Beta Naphthol; Naphthol; metal-organic complexes; Isoindoline and Isoindolinone; Quinacridone; perylene; perinone; anthraquinone; diketo-pyrrolo pyrrole; dioxazine; triacrylcarbonium; the phthalocyanine pigments, such as cobalt phthalocyanine, copper phthalocyanine, copper semichloro- or monochlorophthalocyanine, copper phthalocyanine, metal-free phthalocyanine, copper polychlorophthalocyanine, etc.; organic azo compounds; organic nitro compounds; polycyclic compounds, such as phthalocyanine pigments, quinacridone pigments, perylene and perinone pigments; diketopyrrolo-pyrrole(DPP) pigments; thioindigo pigments; dioxazine pigments; quinophthalone pigments; triacrylcarbonium pigments, and Diaryl pyrrolopyroles, such as PR254.

Non-limiting examples of organic pigments, grouped according to the color they produce (e.g. blues, blacks, greens, yellow, reds and browns), based on their color index include: Pigment Yellows 1, 11, 3, 12, 13, 14, 17, 81, 83, 65, 73, 74, 75, 97, 111, 120, 151, 154, 175, 181, 194, 93, 94, 95, 128, 166, 129, 153, 109, 110, 173, 139, 185, 138, 108, 24; Pigment Oranges 5, 36, 60, 62, 65, 68, 61, 38, 69, 31, 13, 34, 43, 51, 71, 73; Pigment Reds 3, 4, 171, 175, 176, 185, 208, 2, 5, 12, 23, 112, 146, 170, 48, 57, 60, 68, 144, 166, 214, 220, 221, 242, 122, 192, 202, 207, 209, 123, 149, 178, 179, 190, 224, 177, 168, 216, 226, 254, 255, 264, 270, 272; Pigment Violets 32, 19, 29, 23, 37; Pigment Browns 25, 23; Pigment Blacks 1, 31, 32, 20; Pigment Blues 15, 15:1, 15:2, 15:3, 15:4, 15:6, 16, 60; and Pigment Greens 7, 36.

It is preferred that the particle size distributions (or emulsion droplet size distribution, if applicable) contain particles (or droplets) of micronized size. The term “micronized” as used herein means a particle size in the range of 0.001 to 25 microns. It should be understood that “micronized” does not refer only to particles which have been produced by the finely dividing, such as by mechanical grinding, of materials which are in bulk or other form. Micronized particles can also be formed by other mechanical, chemical or physical methods, such as, for example, formation in solution or in situ, with or without a seeding agent, grinding or impinging jet. The term “particle size” refers to the largest axis of the particle. In the case of a generally spherical particle, the largest axis is the diameter.)

The formulations of inorganic and/or organic pigments can be obtained by grinding the pigments, optionally wetted or present as a dispersion, to the desired particle size using a grinding mill. Other particulating methods known in the art can also be used, such as high speed, high shear mixing or agitation. The resulting particulate additive can be mixed with an aqueous liquid carrier to form a solution of dispersed additive particles. Optionally, the solution can comprise a thickener, such as, for example, a cellulose derivative, as is known in the art and/or resin binder, such as polyacrylic, polyurethane, and other known in the art. The solution can, optionally, additionally comprise other biocides, organic or inorganic, micronized if desired, to produce a formulation suitable for the preservation of wood and other cellulose-based materials.

The particles are preferably dispersed and stabilized in a dispersant, such as acrylic copolymers, aqueous solution of copolymers with pigment affinity groups, modified polyacrylate, acrylic polymer emulsions, modified lignin and the like. If desired, a stabilizer as is known in the art can be used.

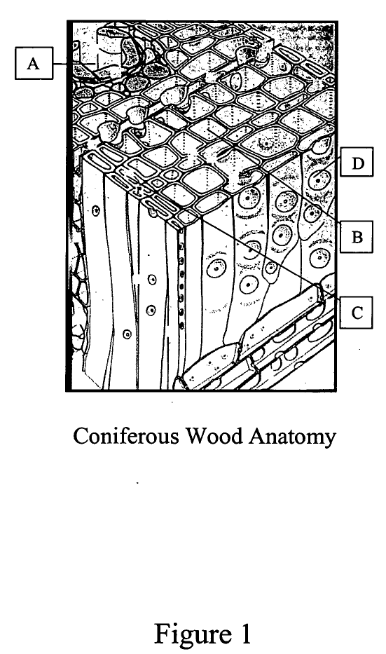

The penetration of the pigment dispersion formulation into the cellular structure of wood or other cellulose-based material is dependent upon particle size considerations. If the inorganic/organic pigments used in formulating the dispersion formulation disclosed herein have a particle size in excess of 30 microns, the particles may be filtered by the surface of the wood and thus may not be uniformly distributed within the cell and cell wall. As shown in FIG. 1, the primary entry and movement of fluids through wood tissue occurs primarily through the tracheids and border pits. Tracheids have a diameter of about thirty microns. Fluids are transferred between wood cells by means of border pits.

Without desiring to be bound by theory, penetration of the micronized dispersion formulation into wood takes place because particles migrate into or are taken up by tracheids in the wood. FIG. 1 shows the physiological structure of wood. As shown in FIG. 1, the primary entry and movement of fluids through wood tissue occurs primarily through the tracheids and border pits. Fluids are transferred between wood cells by means of border pits, which are generally smaller in diameter than the tracheids. When wood is treated with micronized pigment dispersion, if the particle size of the pigment is less than the diameter of the pit openings, a complete penetration and a uniform distribution of micronized preservative in wood is expected. Wood tracheids generally have diameters of around 30 microns, and good penetration can be achieved by the use of particles having long axis dimensions (“particle size” which are less than the tracheid diameters of the wood or wood product to be treated. Particles having diameters which are larger than the average diameter of the tracheids will generally not penetrate the wood (i.e., they will be “filtered” by the wood) and may block, or “clog” tracheids from taking in additional particles.

The diameter of the tracheids depends upon many factors, including the identity of the wood. As a general rule, if the additives disclosed herein have a particle size in excess of 25 microns, the particles may be filtered by the surface of the wood and thus may not be uniformly distributed within the cell and cell wall.

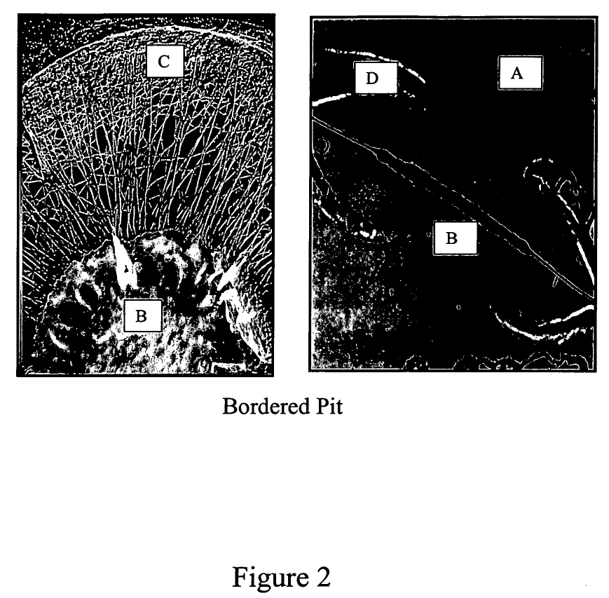

Studies by Mercury-Porosimetry technique indicated that the overall diameter of the border pit chambers typically varies from a several microns up to thirty microns while, the diameter of the pit openings (via the microfibrils) typically varies from several hundredths of a micron to several microns. FIG. 2 depicts the border pit structure for coniferous woods. Thus, in order to maximize penetration and uniformity of distribution of the particulate composition, the particle size should be such that it can travel through the pit openings.

In one embodiment particle size of the micronized pigment particles used in the dispersion formulation disclosed herein can be micronized, i.e., with a long axis dimension between 0.001-25 microns. In another embodiment, the particle size is between 0.001-10 microns. In another embodiment, the particle size is between 0.01 to 10 microns. If superior uniformity of penetration is desired, particle size of the additive used in the dispersion formulation disclosed herein should be between 0.01-1 microns.

It should be noted that the above does not exclude the presence of particles outside the stated ranges. However, particles which are too large can clog the wood, preventing it from taking in other particles and particles which are too small can leach from the wood. Thus particle size distributional parameters can affect the uniformity of particle distribution in the wood, as well as the leaching properties of treated wood. It is thus preferable to use particle size distributions which contain relatively few particle sizes outside the range of 0.001 to 25 microns. It is preferred that no more than 20 weight percent of the particles have diameters which are greater than 25 microns. Because smaller particles have an increased chance of leaching from the wood, it is also preferred that no more than 20 wt % of the particles have diameters under 0.001 microns. Regardless of the foregoing recommendations, it is generally preferred that at least 60%, and more preferably, at least than 80 wt % of the particles have a diameter in the range of 0.001 to 25 microns. In more preferred embodiments, greater than 85, 90, 95 or 99 wt percent particles are in the range of 0.001 to 25 microns.

For increased degree of penetration and uniformity of distribution, at least 50 wt % of the particles should have diameters which are less than 10 microns. More preferred are particle distributions which have at least 65 wt % of the particles with sizes of less than 10 microns. In an additional embodiment, less than 20 wt % of the particles have diameters of less than 1 micron.

Compositions which include other micronized components, such as micronized organic and/or inorganic preservatives and/or biocides, are within the ambit of the present invention. The above particle size considerations apply to the total particulate content, whether the particles are pigments or other particulate composition components.

In order to further improve the weathering properties and the lightfastness of the pigment treated wood or further improve the adhesion of pigment particles to wood, a resin binder is often used in the composition. Examples of resin binders which can be used include polyurethane, polyester, polyvinyl alcohol, polyamide, epoxy, acrylic polymers, vinyl polymers (including polymers made from ethylenically unsaturated monomers such as polybutene), cellulosic derivatives, oligomers and natural polymers, can be either added to the pigment dispersion or added to the final treating composition. Examples of resin binders include:

1). Natural resins, such as fatty vegetable oils, mixtures of complex cyclic or aromatic acids, fish oils, and the like.

2). Vinyl based resins, such as polyethylene, polypropylene, polyvinyl chloride, polyvinyl alcohol, polystyrene, polyalpha methyl styrene, polyvinyl acetate, polymethyl methacrylate, polyacrylonitrile, polyvinyl ethyl ether, polyvinylidene fluoride and the like.

3). Acrylic resins, such as polyacrylic acid, polymethacrylic acid, polyethyl acrylate, polymethyl methacrylate, polylauryl methacrylate, poly2-hydroxyethyl acylate, polyglycidal methaacylate, polyacrylamide, polyhexane diol diacylate, polytrimethylol propane triacrylate, polycarboxylic acid, and the like.

4). Hydrocarbon resins and bituminous binders, such as petroleum oil-derived hydrocarbon resins, terpene resins, ketone resins, asphltite, petroleum asphalts, bituminous mastics, asphaltic hybrids, and the like.

5). Cellulosic resins, such as nitrocellulose, cellulose acetate, cellulose acetate butyrate, ethylcellulose, carboxylmethyl cellulose, methyl cellulose, ethyl cellulose, hydroxyethyl cellulose, hydroxypropyl cellulose, methyl hydroxyethyl cellulose, and the like.

6). Vegetable oils and modified vegetable oils, such as castor oil, linseed oil, tung oil, soya oil, tall oil, safflower oil, fish oil, and the like.

7). Alkyd resins, such as polyethylene glycol, polyneopentyl glycol, polyglycerol, polypentaerythritol, polybenzoic acid, polyabietic acid, polyterephthalic acid, polytrimellitic anhydride, polyisophthalic acid, polyamide-modified alkyds, and the like.

8). Polyester and polyesteramide resins, such as polyethylene terephthalate. The polyesters can be obtained, as well known, by polycondensation of dicarboxylic acids with polyols, in particular diols. The polyesteramides can be obtained in a similar manner to that for the polyesters, by polycondensation of diacids with diamines or amino alcohols, and the like.

9). Formaldehyde resins, such as phenolic resins including phenolic novolacs, phenolic resoles, phenolic epoxies, and phenolic modified rosins, amino resins including urea formaldehyde resins, melamine formaldehyde resins and hexamethoxymethyl melamine resins, and the like.

10). Epoxy resins, such as bisphenol A based epoxy resins, bisphenol F epoxy resins, polyglycol epoxy resins, cardanol-based epoxies and brominated epoxies, and the like.

11). Polyurethanes: The polyurethanes may be chosen from anionic, cationic, nonionic or amphoteric polyurethanes, acrylic polyurethanes, polyurethane-polyvinylpyrrolidones, polyester-polyurethanes, polyether-polyurethanes, polyureas, polyurea-polyurethanes and mixtures thereof. The polyurethane can be, for example, an aliphatic, cycloaliphatic or aromatic polyurethane, polyurea/urethane or polyurea copolymer containing, alone or as a mixture: one sequence of linear or branched aliphatic and/or cycloaliphatic and/or aromatic polyester origin, and/or one sequence of aliphatic and/or cycloaliphatic and/or aromatic polyether origin. The polyurethanes can also be obtained from branched or unbranched polyesters, or from alkyds containing labile hydrogens which are modified by reaction with a diisocyanate and a difunctional (for example dihydro, diamino or hydroxyamino) organic compound, in addition containing either a carboxylic acid or carboxylate group, or a sulphonic acid or sulphonate group, or alternatively a tertiary amine group or a quaternary ammonium group, and the like.

12). Silicone Resins: the silicone compounds, in emulsion, are preferably polyorganosiloxanes, which can be provided in the form of oils, in particular, volatile or nonvolatile silicone oil, of gums, of resins, of pasty products or of waxes, or their mixtures. The silicone gums, waxes and resins can be mixed with silicone oils in which they may be dissolved, the mixture being in the form of an oil-in-water emulsion.

13). Silicate resins, such as alkali silicate binders, alkyl silicate binders, cementitious binders and zinc rich silicate binders, and the like.

In addition to the pigment dispersions, the present invention also comprises an inorganic and/or organic biocide component. This component may be micronized, emulsified, or present in solution. Non-limiting examples of inorganic biocides include materials such as metals and metal compounds, as well as alkaline metal complexes and other metal complexes. Suitable metals include copper, arsenic, zinc, silver, cadmium, nickel, bismuth, lead and chromium, with copper being preferred. Suitable metal compounds and complexes can be obtained commercially as concentrates, such as copper oxides, copper carbonate, copper 8-hydroxyquinolate (oxine copper), and non-limiting examples of commercially available metal complex preservative concentrates that can be used in the current invention are listed below, with compounds (1) through (10) being non-limiting examples of alkaline metal complexes:

(1) Ammoniacal copper arsenate: containing about 45.0-55.0% copper as copper oxide and about 45.0-55.0% arsenic as arsenic pentaoxide.

(2) Ammoniacal copper zinc arsenate: containing about 45.0-55.0% copper as copper oxide, about 22.5-27.5% zinc as zinc oxide and about 22.5-27.5% arsenic as arsenic oxide.

(3) ACQ-type A: containing about 45.0-55.0% copper as copper oxide and about 45.0-55.0% quaternary ammonium compounds.

(4) ACQ-type B: containing about 62.0-71.0% copper as copper oxide and about 29.0-38.0% quaternary ammonium compounds.

(5) ACQ-type C: containing about 62.0-71.0% copper as copper oxide and about 29.0-38.0% quaternary ammonium compounds.

(6) ACQ-type D: containing about 62.0-71.0% copper as copper oxide and about 29.0-38.0% quaternary ammonium compounds.

(7) Cu—HDO: containing about 58-65% copper as copper oxide, about 10-18% % bis-(N-cyclohexyldiazeniumdioxide) (HDO) and about 17-32% boron as boric acid.

(8) Ammoniacal copper citrate: containing about 59.0-68.0% copper as copper oxide and about 32.0-41.0% citric acid.

(9) Copper Azole-typeA (CBA-A): containing about 44.0-54.0% copper, about 44.0-54.0% boron as boric acid and about 1.8-2.8% azole as tebuconazole.

(10) Copper Azole-typeB(CA-B): containing about 95.4-96.8% copper and 3.2-4.6% azole as tebuconazole.

In addition to or instead of the metal complexes, the present invention can also comprise organic biocidal compounds. Some non-limiting examples of organic biocides are listed as follows:

Aliphatic Nitrogen Fungicides

butylamine; cymoxanil; dodicin; dodine; guazatine; iminoctadine

Amide Fungicides

carpropamid; chloraniformethan; cyazofamid; cyflufenamid; diclocymet; ethaboxam; fenoxanil; flumetover; furametpyr; prochloraz; quinazamid; silthiofam; triforine benalaxyl; benalaxyl-M; furalaxyl; metalaxyl; metalaxyl-M; pefurazoate; benzohydroxamic acid; tioxymid; trichlamide; zarilamid; zoxamide cyclafliramid; furmecyclox dichlofluanid; tolylfluanid benthiavalicarb; iprovalicarb benalaxyl; benalaxyl-M;boscalid; carboxin; fenhexamid; metalaxyl; metalaxyl-M metsulfovax; ofurace; oxadixyl; oxycarboxin; pyracarbolid; thifluzamide; tiadinil benodanil; flutolanil; mebenil; mepronil; salicylanilide; tecloftalam fenfuram; furalaxyl; furcarbanil; methfuroxam flusulfamide

Antibiotic Fungicides

aureofungin; blasticidin-S; cycloheximide; griseofulvin; kasugamycin; natamycin; polyoxins; polyoxorim; streptomycin; validamycin azoxystrobin dimoxystrobin fluoxastrobin kresoxim-methyl metominostrobin orysastrobin picoxystrobin pyraclostrobin trifloxystrobin

Aromatic Fungicides

biphenyl chlorodinitronaphthalene chloroneb chlorothalonil cresol dicloran hexachlorobenzene pentachlorophenol quintozene sodium pentachlorophenoxide tecnazene

Benzimidazole Fungicides

benomyl carbendazim chlorfenazole cypendazole debacarb fuberidazole mecarbinzid rabenzazole thiabendazole

Benzimidazole Precursor Fungicides

furophanate thiophanate thiophanate-methyl

Benzothiazole Fungicides

bentaluron chlobenthiazone TCMTB

Bridged Diphenyl Fungicides

bithionol dichlorophen diphenylamine

Carbamate Fungicides

benthiavalicarb furophanate iprovalicarb propamocarb thiophanate thiophanate-methyl benomyl carbendazim cypendazole debacarb mecarbinzid diethofencarb

Conazole Fungicides

climbazole clotrimazole imazalil oxpoconazole prochloraz triflumizole azaconazole bromu conazole cyproconazole diclobutrazol difenoconazole diniconazole diniconazole-M epoxiconazole etaconazole fenbuconazole fluguinconazole flusilazole flutriafol furconazole furconazole-cis hexaconazole imibenconazole ipconazole metconazole myclobutanil penconazole propiconazole prothioconazole quinconazole simeconazole tebuconazole tetraconazole triadimefon triadimenol triticonazole uniconazole uniconazole-P

Dicarboximide Fungicides

famoxadone fluoroimide chlozolinate dichlozoline iprodione isovaledione myclozolin procymidone vinclozolin captafol captan ditalimfos folpet thiochlorfenphim

Dinitrophenol Fungicides

binapacryl dinobuton dinocap dinocap-4 dinocap-6 dinocton dinopenton dinosulfon dinoterbon DNOC

Dithiocarbamate Fungicides

azithiram carbamorph cufraneb cuprobam disulfiram ferbam metam nabam tecoram thiram ziram dazomet etem milneb mancopper mancozeb maneb metiram polycarbamate propineb zineb

Imidazole Fungicides

cyazofamid fenamidone fenapanil glyodin iprodione isovaledione pefurazoate triazoxide

Morpholine Fungicides

aldimorph benzamorf carbamorph dimethomorph dodemorph fenpropimorph flumorph tridemorph

Organophosphorus Fungicides

ampropylfos ditalimfos edifenphos fosetyl hexylthiofos iprobenfos phosdiphen pyrazophos tolclofos-methyl triamiphos

Oxathiin Fungicides

carboxin oxycarboxin

Oxazole Fungicides

chlozolinate dichlozoline drazoxolon famoxadone hymexazol metazoxolon myclozolin oxadixyl vinclozolin

Pyridine Fungicides

boscalid buthiobate dipyrithione fluazinam pyridinitril pyrifenox pyroxychlor pyroxyfur

Pyrimidine Fungicides

bupirimate cyprodinil diflumetorim dimethirimol ethirimol fenarimol ferimzone mepanipyrim nuarimol pyrimethanil triarimol

Pyrrole Fungicides

fenpiclonil fludioxonil fluoroimide

Quinoline Fungicides

ethoxyquin halacrinate 8-hydroxyguinoline sulfate quinacetol quinoxyfen

Quinone Fungicides

benguinox chloranil dichlone dithianon

Quinoxaline Fungicides

chinomethionat chlorquinox thioquinox

Thiazole Fungicides

ethaboxam etridiazole metsulfovax octhilinone thiabendazole thiadifluor thifluzamide

Thiocarbamate Fungicides

methasulfocarb prothiocarb

Thiophene Fungicides

ethaboxam silthiofam

Triazine Fungicides

anilazine

Triazole Fungicides

bitertanol fluotrimazole triazbutil

Urea Fungicides

bentaluron pencycuron quinazamid

Other Fungicides

acibenzolar acypetacs allyl alcohol benzalkonium chloride benzamacril bethoxazin carvone chloropicrin DBCP dehydroacetic acid diclomezine diethyl pyrocarbonate fenaminosulf fenitropan fenpropidin formaldehyde furfural hexachlorobutadiene iodomethane isoprothiolane methyl bromide methyl isothiocyanate metrafenone nitrostyrene nitrothal-isopropyl OCH 2 phenylphenol phthalide piperalin probenazole proquinazid pyroquilon sodium orthophenylphenoxide spiroxamine sultropen thicyofen tricyclazole. methyl isothiocyanate

Preferred insecticides which can be mixed micronized metal formulations are:

Antibiotic Insecticides

allosamidin thuringiensin spinosad abamectin doramectin emamectin eprinomectin ivermectin selamectin milbemectin milbemycin oxime moxidectin

Botanical Insecticides

anabasine azadirachtin d-limonene nicotine pyrethrins cinerins cinerin I cinerin II jasmolin I jasmolin II pyrethrin I pyrethrin II quassia rotenone ryania sabadilla

Carbamate Insecticides

bendiocarb carbaryl benfuracarb carbofuran carbosulfan decarbofuran furathiocarb dimetan dimetilan hyquincarb pirimicarb alanycarb aldicarb aldoxycarb butocarboxim butoxycarboxim methomyl nitrilacarb oxamyl tazimcarb thiocarboxime thiodicarb thiofanox allyxycarb aminocarb bufencarb butacarb carbanolate cloethocarb dicresyl dioxacarb EMPC ethiofencarb fenethacarb fenobucarb isoprocarb methiocarb metolcarb mexacarbate promacyl promecarb propoxur trimethacarb XMC xylylcarb

Dinitrophenol Insecticides

dinex dinoprop dinosam DNOC cryolite sodium hexafluorosilicate sulfluramid

Formamidine Insecticides

amitraz chlordimeform formetanate formparanate

Fumigant Insecticides

acrylonitrile carbon disulfide carbon tetrachloride chloroform chloropicrin para-dichlorobenzene 1,2-dichloropropane ethyl formate ethylene dibromide ethylene dichloride ethylene oxide hydrogen cyanide iodomethane methyl bromide methylchloroform methylene chloride naphthalene phosphine sulfuryl fluoride tetrachloroethane

Insect Growth Regulators

bistrifluron buprofezin chlorfluazuron cyromazine diflubenzuron flucycloxuron flufenoxuron hexaflumuron lufenuron novaluron noviflumuron penfluron teflubenzuron triflumuron epofenonane fenoxycarb hydroprene kinoprene methoprene pyriproxyfen triprene

juvenile hormone I

juvenile hormone II

juvenile hormone III

chromafenozide halofenozide methoxyfenozide tebufenozide α-ecdysone ecdysterone diofenolan

precocene I

precocene II

precocene III

dicyclanil

Nereistoxin Analogue Insecticides

bensultap cartap thiocyclam thiosultap flonicamid clothianidin dinotefuran imidacloprid thiamethoxam nitenpyram nithiazine acetamiprid imidacloprid nitenpvyram thiacloprid

Organochlorine Insecticides

bromo-DDT camphechlor DDT pp′-DDT ethyl-DDD HCH gamma-HCH lindane methoxychlor pentachlorophenol TDE aldrin bromocyclen chlorbicyclen chlordane chlordecone dieldrin dilor endosulfan endrin HEOD heptachlor HHDN isobenzan isodrin kelevan mirex

Organophosphorus Insecticides

bromfenvinfos chlorfenvinphos crotoxyphos dichlorvos dicrotophos dimethylviphos fospirate heptenophos methocrotophos mevinphos monocrotophos naled naftalofos phosphamidon propaphos schradan TEPP tetrachlorvinphos dioxabenzofos fosmethilan phenthoate acethion amiton cadusafos chlorethoxyfos chlormephos demephion

demephion-O

demephion-S demeton

demeton-O

demeton-S demeton-methyl

demeton-O-methyl

demeton-S-methyl demeton-S-methylsulphon

disulfoton ethion ethoprophos IPSP isothioate malathion methacrifos oxydemeton-methyl oxydeprofos oxydisulfotonphorate sulfotep terbufos thiometonamidithion cyanthoate dimethoate ethoate-methyl fonnothion mecarbam omethoate prothoate sophamide vamidothion chlorphoxim phoxim phoxim-methyl azamethiphos coumaphos coumithoate dioxathion endothion menazon morphothion phosalone pyraclofos pyridaphenthion quinothion dithicrofos thicrofos azinphos-ethvl azinphos-methyl dialifos phosmet isoxathion zolaprofos chlorprazophos pyrazophos chlorpyrifos chlorpyrifos-methyl butathiofos diazinon etrimfos lirimfos pirimiphos-ethyl pirimiphos-methyl primidophos pyrimitate tebupirimfos quinalphos quinalphos-methyl athidathion lythidathion methidathion prothidathion isazofos triazophos azothoate bromophos bromophos-ethyl carbophenothion chlorthiophos cyanophos cythioate dicapthon dichlofenthion etaphos famphur fenchlorphos fenitrothion fensulfothion fenthion fenthion-ethyl heterophos jodfenphos mesulfenfos parathion parathion-methyl phenkapton phosnichlor profenofos prothiofos sulprofos temephos trichlormetaphos-3 trifenofos butonate trichlorfon mecarphon fonofos trichloronat cyanofenphos EPN leptophos crufomate fenamiphos fosthietan mephosfolan phosfolan pirimetaphos acephate isocarbophos isofenphos methamidophos propetamphos dimefox mazidox mipafox

Oxadiazine Insecticides

indoxacarb

Phthalimide Insecticides

dialifos phosmet tetramethrin

Pyrazole Insecticides

acetoprole ethiprole fipronil tebufenpyrad tolfenpyrad vaniliprole

Pyrethroid Insecticides

acrinathrin allethrin bioallethrin barthrin bifenthrin bioethanomethrin cyclethrin cycloprothrin cyfluthrin beta-cyfluthrin cyhalothrin gamma-cyhalothrin lambda-cyhalothrin cypermethrin alpha-cypermethrin beta-cypermethrin theta-cypermethrin zeta-cypermethrin cyphenothrin deltamethrin dimefluthrin dimethrin empenthrin fenfluthrin fenpirithrin fenpropathrin fenvalerate esfenvalerate flucythrinate fluvalinate tau-fluvalinate furethrin imiprothrin metofluthrin permethrin biopermethrin transpermethrin phenothrin prallethrin profluthrin pyresmethrin resmethrin bioresmethrin cismethrin tefluthrin terallethrin tetramethrin tralomethrin transfluthrin etofenprox flufenprox halfenprox protrifenbute silafluofen

Pyrimidinamine Insecticides

flufenerim pyrimidifen

Pyrrole Pnsecticides

chlorfenapyr

Tetronic Acid Insecticides

spiromesifen

Thiourea Insecticides

diafenthiuron

Urea Insecticides

flucofuron

sulcofuron

Other Insecticides

closantel crotamiton EXD fenazaflor fenoxacrim hydramethylnon isoprothiolane malonoben metoxadiazone nifluridide pyridaben pyridalyl rafoxanide triarathene triazamate

Preferred bactericides include:

bronopol cresol dichlorophen dipyrithione dodicin fenaminosulf formaldehyde hydrargaphen 8-hydroxyquinoline sulfate kasugamycin nitrapyrin octhilinone oxolinic acid oxytetracycline probenazole streptomycin tecloftalam thiomersal

Preferred biocides include: cyproconazole, propiconazole, tebuconazole, 2-(thiocyanatomethylthio) benzothiazole, chlorothalonil, isothiazolone, Iodopropynyl Butylcarbamate, imidachloprid, bifenthrin, cypermethrin, permethrin, fipronil, carbendazim, 4,5-dichloro-2-n-octyl-3-isothiazolone (DCOIT), quaternary ammonium compounds

Organic biocides also include quaternary ammonium compounds disclosed in the present invention have the following structures: 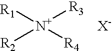
Where R1, R2, R3, and R4 are independently selected from alkyl or aryl groups and X⁻ selected from chloride, bromide, iodide, carbonate, bicarbonate, borate, carboxylate, hydroxide, sulfate, acetate, laurate, or any other anionic group.

Preferred quaternary ammonium compounds include alkyldimethylbenzylammonium chloride, alkyldimethylbenzylammonium carbonate/bicarbonate, dimethyldidecylammonium chloride, dimethyldidecylammonium carbonate/bicarbonate, dimethyldidodecylammonium chloride, dimethyldidodecylammonium carbonate/bicarbonate.

In the composition of the present invention, it is preferable that the pigment dispersion be present in the solution applied to wood in amounts in the range of from 0.005 to 50 weight percent of the solution, with a preferred range of 0.01 to 20%, and a more preferred range of 0.05 to 10%.

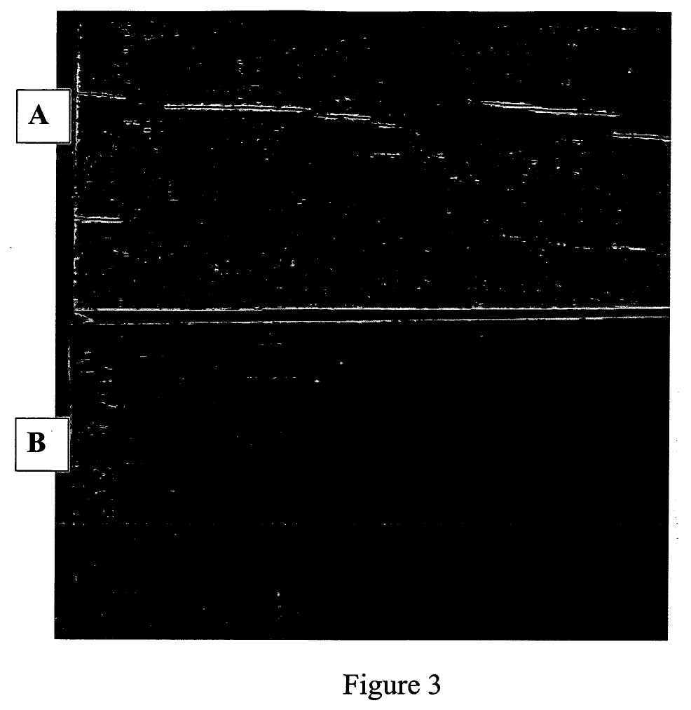

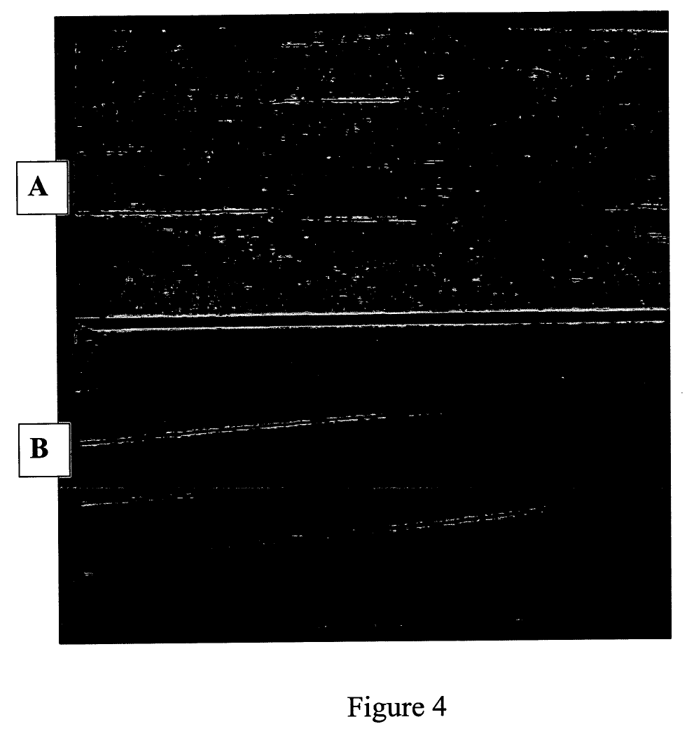

A wide range of useful colors can be imparted to wood using the process of the present invention. The color of wood treated with the preservative solutions described herein can be a variety of colors, such as grey, blue, green, brown, yellow, orange, black, red or any other shades, depending upon the particular combination of the pigments, and their concentration. Dramatic improvement on the weathering properties can be achieved by incorporating the pigments into the preservative systems as shown in FIGS. 3 and 4. The samples in FIG. 3 were treated with a tebuconazole based wood preservative and the samples in FIG. 4 with a quaternary ammonium compound-based wood preservative (dimethyl didecyl ammonium carbonate/bicarbonate). Specifically, the samples in FIG. 3A and 4A were treated with the preservatives alone, while the sample in FIG. 3B was treated with the preservative plus a red-brown iron oxide-based pigment formulation and 4B with the preservative plus a iron oxide/carbon black-based green pigment formulation. The samples were then subjected to outdoor weathering. The samples treated with preservative alone showed poor weathering characteristics: delignification, surface graying, darkening, and mold growth, while the samples treated with preservatives plus pigments demonstrated excellent photo-resistance and overall color integrity.

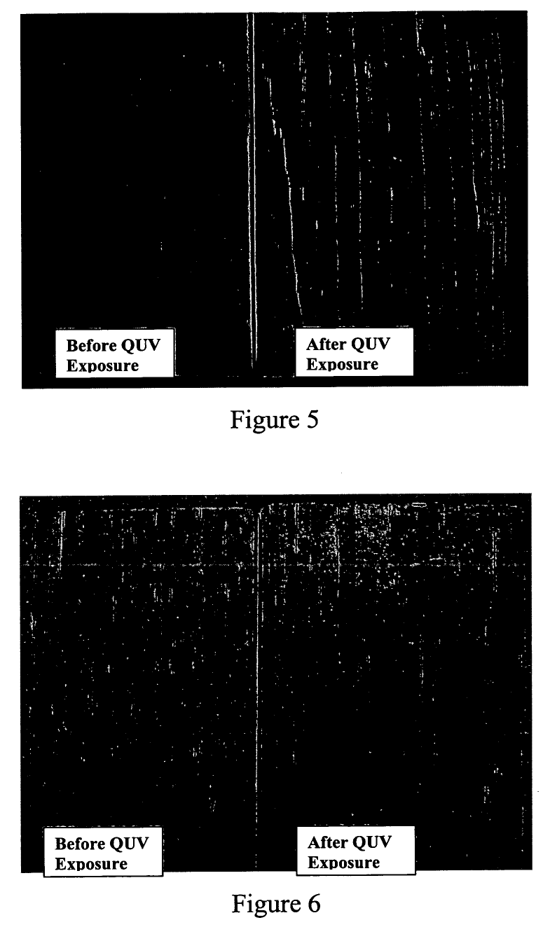

Laboratory accelerated weathering test (QUV Test: samples exposed to UV light and water spraying) also confirms that the wood samples treated with preservative plus pigment formulation demonstrated great UV photo-resistance. FIGS. 5 and 6 demonstrated the effect of QUV test on the wood samples treated with a preservative alone (tebuconazole and bifenthrin) and the preservative plus a light-brown pigment formulation (iron oxide-based), respectively. Deligninfication and graying were observed on the preservative alone treated sample after one month QUV weathering, while only slight color change was observed the sample treated with the preservative plus the pigment after one month QUV weathering.

By applying the composition of the present invention to wood, it can be simultaneously preserved and colored with the application of a single solution. The treating composition may be applied to wood by dipping, soaking, spraying, brushing, or any other means well known in the art. In a preferred embodiment, vacuum and/or pressure techniques are used to impregnate the wood in accord with this invention including the standard processes, such as the “Empty Cell” process, the “Modified Full Cell” process and the “Full Cell” process, and any other vacuum and /or pressure processes which are well known to those skilled in the art.

The standard processes are defined as described in AWPA Standard C1-03 “All Timber Products—Preservative Treatment by Pressure Processes”. In the “Empty Cell” process, prior to the introduction of preservative, materials are subjected to atmospheric air pressure (Lowry) or to higher air pressures (Rueping) of the necessary intensity and duration. In the “Modified Full Cell”, prior to introduction of preservative, materials are subjected to a vacuum of less than 77 kPa (22 inch Hg) (sea level equivalent). A final vacuum of not less than 77 kPa (22 inch Hg) (sea level equivalent) should be used. In the “Full Cell Process”, prior to introduction of preservative or during any period of condition prior to treatment, materials are subjected to a vacuum of not less than 77 kPa (22 inch Hg). A final vacuum of not less than 77 kPa (22 inch Hg) is used.

The present invention also provides a method for preservation of wood. In one embodiment, the method comprises the steps of treating wood with a treating fluid comprising a dispersion of micronized pigment particles and a wood preservative according to conventional wood treatment cycles employing for example, the Full Cell or Empty Cell process, some combination thereof, or by dip or spray treatment.

It is preferable to color and preserve the wood simultaneously, however it can be desirable to treat and color the wood in two stages. Without departing from the teachings of this invention the wood may first be treated with a composition containing wood preservatives, and then contacted with a composition containing the pigment dispersion. It is also possible to apply the coloring agent to the wood initially, followed by the application of the preservative composition. The application of each component can be carried out as with the application of a two component solution.

The two step application is particularly useful in wood treatment processes in which the runoff from treatment with one component is to be collected and reused.

The following examples will serve to further illustrate the invention: The following examples will serve to further illustrate the invention. Examples 1 through 6 demonstrate the preparation of pigment dispersion. Example 7 through 14 demonstrates the preparation of the wood preservative treating compositions with and without the presence of pigment dispersions.

### EXAMPLE 1

Six hundred grams of red iron oxide, 400 g yellow iron oxide and 10 g carbon black were added to a container containing 2850.0 g of water and 150 g of a commercially available dispersant. The mixture was mechanically stirred for about 20 minutes and then added to a grinding mill. The sample was ground for about 1 hour and a stable dispersion was obtained. The particle size of the dispersed product was analyzed by Horiba LA-910 Particle Size Distribution Analyzer (PSDA). The average particle size was 0.21 microns with a distribution range of 0.04 um to 1.5 um.

### EXAMPLE 2

Seven hundred grams of red iron oxide, 200 g yellow iron oxide and 5 g black iron oxide were added to a container containing 2050 g of water and 180 g of a commercially available dispersant. The mixture was mechanically stirred for about 20 minutes and then added to a grinding mill. The sample was ground for about 1 hour and a stable dispersion was obtained. The particle size of the dispersed product was analyzed by Horiba LA-910 Particle Size Distribution Analyzer (PSDA). The average particle size was 0.25 microns with a distribution range of 0.005 um to 2.0 um.

### EXAMPLE 3

Eight hundred and ninety grams of yellow iron oxide, 110 g red iron oxide were added to a container containing 3000 g of water and 200 g of a commercially available dispersant. The mixture was mechanically stirred for about 20 minutes and then added to a grinding mill. The sample was ground for about 1 hour and a stable dispersion was obtained. The particle size of the dispersed product was analyzed by Horiba LA-910 Particle Size Distribution Analyzer (PSDA). The average particle size was 0.24 microns with a distribution range of 0.005 um to 2.0 um.

### EXAMPLE 4

Five hundred grams of organic pigment yellow PY65, 600 g of organic pigments red PR23 and 15 g organic pigment blue PB 15 were added to a container containing 3000 g of water and 450 g of a commercially available dispersant. The mixture was mechanically stirred for about 20 minutes and then added to a grinding mill. The sample was ground for about 1 hour and a stable dispersion was obtained. The particle size of the dispersed product was analyzed by Horiba LA-910 Particle Size Distribution Analyzer (PSDA). The average particle size was 0.18 microns with a distribution range of 0.001 um to 2.0 um.

### EXAMPLE 5

Eight hundred grams of organic pigment yellow PY 13 and 100 g of organic pigments red PR254 were added to a container containing 4000 g of water and 500 g of a commercially available dispersant. The mixture was mechanically stirred for about 20 minutes and then added to a grinding mill. The sample was ground for about 1 hour and a stable dispersion was obtained. The particle size of the dispersed product was analyzed by Horiba LA-910 Particle Size Distribution Analyzer (PSDA). The average particle size was 0.21 microns with a distribution range of 0.001 um to 2.0 um.

### EXAMPLE 6

Five hundred grams of titanium dioxide is mixed with 450 grams of water and 50 grams of commercially available wetting agents/dispersants. The mixture is mechanically stirred for 5 minutes. The mixture is then placed in a grinding mill and ground for about 30 minutes. A stable dispersion is obtained with an average particle size of 0.29 microns.

### EXAMPLE 7

Southern Yellow Pine, (measuring 2″×6″×4′) was simultaneously colored and preserved by the Full Cell treatment using a 1.1% ACQ-B solution containing 0.73% copper oxide and 0.37% quaternary ammonium compound (dimethyl didecyl ammonium carbonate/bicarbonate), and 0.40% pigment solids from Example 1. The wood was initially placed under a vacuum of 30″ Hg for 30 minutes followed by the addition of the treating solution. The system was then pressurized for 30 minutes at a pressure of 110 lbs. per square inch. The resulting wood, when dried, was colored brown and protected against wood destroying organisms.

### EXAMPLE 8

Southern Yellow Pine blocks (1½″×2″×6″) were simultaneously colored and preserved utilizing the Lowry Empty Cell process using a 0.5% quaternary ammonium compounds based preservative (dimethyl didecyl ammonium chloride) plus 0.35% pigment solids from Example 2 and 0.030% hydroxyethyl cellulose binder. The resulting wood was air dried to a 20% moisture content and was colored a reddish brown color uniformly distributed on the surface of the treated wood. The wood was exposed under an accelerated tester (QUV) and found to exhibit great resistance to UV photo-degradation. Laboratory accelerated agar test indicated that the treated wood resist both attacks from brown rots and white rots.

### EXAMPLE 9

64 grams of pigment concentrate from Example 3 were mixed with 3936 g dimethyldidecylammonium carbonate (DDA Quat) water solution with DDA Quat concentration of 0.60% and 0.05% polyvinyl alcohol resin. The solution was used to treat red pine and ponderosa pine samples using the Full Cell process. The resulting wood was oven dried at 120° F. and was colored a light brown color. Outdoor exposure studies indicated that the treated samples were resistant to biological deterioration and UV degradation.

### EXAMPLE 10

Southern Yellow Pine blocks (½″×2″×6″) were simultaneously colored and preserved using the Full Cell treatment with a treating composition containing 0.10% copper 8-hydroxyquinolate plus 0.10% pigment dispersion from Example 4 with 0.005% a commercially available binder. The Southern Yellow Pine blocks were placed in a cylinder and a vacuum of 30″ Hg applied for 15 minutes, the treating composition was then added to the cylinder and the system pressurized to 100 lbs. per square inch for 30 minutes. The resulting wood, when dried, was colored a reddish brown and was protected against wood destroying organisms.

### EXAMPLE 11

Douglas fir and Hem fir wood samples were colored a light brown color with a two-step process. Step I involved the treatment of wood with 0.8% dimethyldidecylammonium carbonate solution using the Full Cell process, followed by Step II treatment with a 1.0% pigment solution from Example 3. The treated wood showed great bio-efficacy and color stability when exposed outside.

### EXAMPLE 12

Southern pine, red pine and ponderosa pine samples were colored a darker reddish brown color with a two-step process. Step I involved the treatment of wood with a 2.0% pigment solution from Example 2 plus 0.015% a commercially available binder using a modified Full Cell process, followed by Step II treatment with a composition containing 0.05% tebuconazole and 0.005% bifenthrin. The treated samples demonstrated uniform surface coloration. The samples also demonstrated high bio-efficacy in a field test evaluation.

### EXAMPLE 13

Douglas fir and Hem fir samples were colored a darker reddish brown color with a two-step process. Step I involved the treatment of wood with a composition containing 1.0% dimethyldidecylammonium carbonate solution using the Full Cell process, followed by Step II treatment with a 1.0% pigment solution from Example 2 plus 0.01% a commercially available binder. The treated samples demonstrated uniform coloration on the surface and bio-efficacy in a field test evaluation.

### EXAMPLE 14

Southern Yellow Pine blocks were colored a white/grey color with a two-step process. Step I involved the treatment of wood with 1.1% ACQ-Type D solution using the Full Cell process, followed by Step II treatment with a composition containing 1.0% pigment dispersion from Example 6. The treated samples demonstrated greater color stability when exposed outside, and the samples also showed resistance to decay fungi.

A variety of cellulosic products such as wood, paper, textiles, cotton and the like can be colored and preserved in accordance with this invention including hard and/or soft woods. In general, wood may thus be simultaneously colored and preserved.

Wood colored and preserved according to the method of this invention resists weathering and has many uses in the construction industry. Patio and pool decks, wood siding and beams, fence posts, garden ties and poles for outdoor or indoor use are just a few of the possible products which may incorporate wood treated according to the method described herein.

The foregoing examples are intended to be merely illustrative and should not be construed or interpreted as being restrictive or otherwise limiting of the present invention.

We claim:

1. An aqueous wood preservative composition comprising
a) a pigment component; and
b) a component comprising one or more inorganic and/or organic preservatives or biocides;
wherein a) comprises a dispersion of particles comprising micronized particles.

2. A composition as in claim 1 wherein b) comprises a dispersion of particles comprising micronized particles.

3. A composition as in claim 1 wherein b) is present in solution or as an emulsion.

4. A composition as in claim 1, further comprising a binder.

5. A composition as in claim 2 wherein greater than 60 weight percent of the particles are micronized.

6. A composition as in claim 1 wherein a) comprises one or more organic pigments.

7. A composition as in claim 1 wherein a) comprises one or more inorganic pigments.

8. A composition as in claim 1 wherein a) comprises a pigment selected from the group consisting of carbon black, graphite, iron oxide, black micaceous iron oxide, iron hydroxide, zinc oxide, titanium oxide, titanium dioxide, aluminum oxide and aluminum hydroxide.

9. A composition as in claim 1 wherein a) is iron oxide selected from the group consisting of red iron oxides, yellow iron oxides, black iron oxides and brown iron oxides.

10. A composition as in claim 1 wherein b) comprises one or more inorganic and/or organic preservatives or biocides selected from the group consisting of tebuconazole, bifenthrin, dimethyl didecyl ammonium carbonate/bicarbonate and dimethyl didecyl ammonium chloride, propiconazole, cyproconazole, 4,5 Dichloro-2-N-Octyl-4-isothiazolin-3-one (rh-287) imidacloprid, fipronil, permethrin, cypromethrin.

11. A method for preserving a wood product comprising the step of impregnating the product with the wood preservative composition of claim 1.

12. A method as in claim 11 wherein the product is treated with a composition of claim 1 wherein b) comprises an inorganic and/or organic biocide component comprising a dispersion of particles comprising micronized particles.

13. A method as in claim 11 wherein the product is treated with a composition of claim 1 wherein b) comprises an inorganic and/or organic biocide which is present in solution or as an emulsion.

14. A method as in claim 11 wherein the composition further comprises a binder.

15. A method as in claim 12 wherein greater than 60 weight percent of the particles are micronized.

16. A method as in claim 11 wherein the product is treated with a composition of claim 1 wherein a) comprises one or more organic pigments.

17. A method as in claim 11 wherein the product is treated with a composition of claim 1 wherein a) comprises one or more inorganic pigments.

18. A method as in claim 11 wherein the product is treated with a composition of claim 1 wherein a) comprises a pigment selected from the group consisting of carbon black, graphite, iron oxide, black micaceous iron oxide, iron hydroxide, zinc oxide, titanium oxide, titanium dioxide, aluminum oxide and aluminum hydroxide.

19. A method as in claim 11 wherein the product is treated with a composition of claim 1 wherein a) comprises one or more iron oxides selected from the group consisting of red iron oxides, yellow iron oxides, black iron oxides and brown iron oxides.

20. A method as in claim 11 wherein the product is treated with a composition of claim 1 wherein b) is selected from the group consisting of tebuconazole, bifenthrin, dimethyl didecyl ammonium carbonate/bicarbonate and dimethyl didecyl ammonium chloride, propiconazole, cyproconazole, 4,5 Dichloro-2-N-Octyl-4-isothiazolin-3-one (rh-287) imidacloprid, fipronil, permethrin, cypromethrin.

21. A method for preserving a wood product comprising the steps of:
a) impregnating the wood with a composition comprising a dispersion comprising one or more micronized pigments; and
b) impregnating the wood with a composition comprising one or more organic and/or inorganic preservatives and /or biocides.

22. A method as in claim 21 wherein step a) is conducted before step b).

23. A method as in claim 21 wherein step b) is conducted before step a).

24. A method as in 21 wherein the composition of step b) comprises one or more organic and/or inorganic preservatives and/or biocides which are present in solution or as an emulsion.

25. A method as in claim 21 wherein the composition step a) and/or the composition of step b) further comprise one or more binders.

26. A method as in claim 21 wherein the composition of step a) comprises one or more organic pigments.

27. A method as in claim 21 wherein the composition of step a) comprises one or more inorganic pigments.

28. A method as in claim 21 wherein the wood product is impregnated with a composition in step a) comprising a dispersion comprising one or more pigments selected from the group consisting of carbon black, graphite, iron oxide, black micaceous iron oxide, iron hydroxide, zinc oxide, titanium oxide, titanium dioxide, aluminum oxide and aluminum hydroxide.

29. A method as in claim 21 wherein the product is treated with a composition in step b) comprising one or more inorganic and/or organic biocides present in solution or as an emulsion.

30. A method as in claim 21 wherein the wood product is impregnated with a composition in step a) comprising a dispersion comprising one or more pigments selected from the group consisting of red iron oxides, yellow iron oxides, black iron oxides and brown iron oxides.

31. A method as in claim 21 wherein the wood product is impregnated with a composition in step b) comprising one or more organic and/or inorganic preservatives and/or biocides selected from the group consisting of tebuconazole, bifenthrin, dimethyl didecyl ammonium carbonate/bicarbonate and dimethyl didecyl ammonium chloride, propiconazole, cyproconazole, 4,5 Dichloro-2-N-Octyl-4-isothiazolin-3-one (rh-287) imidacloprid, fipronil, permethrin, cypromethrin.

32. A method as in claim 21 wherein the wood product is impregnated with a composition in step b) comprising a dispersion of particles comprising micronized particles.

33. A method as in claim 32 wherein greater than 60 weight percent of the particles are micronized.
